(19) United States
(12) Patent Application Publication
(10) Pub. No.: US 2004/0025911 A1
(43) Pub. Date: Feb. 12, 2004

(54) Apparatus for cleaning a semiconductor substrate by vibrating cleaning solution supplied onto the substrate

(76) Inventors: In-Ju Yeo, Suwon-Si (KR); Byoung-Moon Yoon, Suwon-Si (KR); Yong-Sun Ko, Suwon-Si (KR); Kyung-Hyun Kim, Seoul (KR); Chang-Lyong Song, Yongin-Si (KR)

Correspondence Address: VOLENTINE FRANCOS, P.L.L.C., Suite 150, 12200 Sunrise Valley Drive, Reston, VA, 20191, US

(21) Appl. No.: 10/394,194

(22) Filed: Mar. 24, 2003

(30) Foreign Application Priority Data
Aug. 9, 2002 (KR) 2002-47250

(51) Int. Cl. B08B 3/10

(52) U.S. Cl. 134/113; 134/146; 134/148; 134/153; 134/184; 134/186; 134/902

(57) ABSTRACT

An apparatus for cleaning a semiconductor substrate has a chuck for rotatably supporting the semiconductor substrate, and a horizontally movable probe for applying ultrasonic vibrations uniformly to cleaning solution supplied onto an upper surface of the semiconductor substrate. The probe makes contact with the cleaning solution supplied and extends vertically from the upper surface of the substrate. The cross-sectional area of the probe gradually increases in a direction towards the semiconductor substrate so that the ultrasonic vibrations are widely distributed to the cleaning solution. The lower surface of the probe has surface features that act to disperse a reflected wavefront of the vibrational energy. Thus, patterns formed on the semiconductor substrate will not be damaged by the ultrasonic vibrations.

### BACKGROUND OF THE INVENTION

1. Field of the Invention

The present invention relates to an apparatus for cleaning a semiconductor substrate. More particularly, the present invention relates to an apparatus for cleaning a semiconductor substrate by applying ultrasonic vibrations to cleaning solution that has been supplied onto a surface of the semiconductor substrate.

2. Description of the Related Art

Generally, a semiconductor device is fabricated by repeatedly performing a series of unit processes, such as deposition, photolithography, etching, chemical and mechanical polishing, cleaning and drying processes. The cleaning process is implemented for the purpose of removing impurities or unnecessary films from a surface of the semiconductor substrate throughout the course of the overall manufacturing process. As the patterns formed on a semiconductor substrate become more minute and the aspect ratios of the patterns become greater, the cleaning process plays an increasingly important role in the overall success of the fabricating process.

Apparatus for performing the cleaning process can be classified as batch type cleaning apparatus and a single-wafer type cleaning apparatus. The batch type cleaning apparatus simultaneously wash a plurality of semiconductor substrates by immersing the semiconductor substrates in a cleaning bath filled with a cleaning solution. Ultrasonic vibrations can be applied to the cleaning bath in order to improve the cleaning efficiency. On the other hand, the single-wafer cleaning apparatus clean the semiconductor substrates one by one. Single-wafer type cleaning apparatus comprise a chuck for supporting the semiconductor substrate and a nozzle for supplying cleaning solution onto an upper surface or a lower surface of the semiconductor substrate. In this case, ultrasonic vibrations can be applied to the cleaning solution before or after the cleaning solution is supplied onto the semiconductor substrate.

An example of a single-wafer type of cleaning apparatus that washes semiconductor substrates by applying ultrasonic vibration to the cleaning solution is disclosed in U.S. Pat. No. 6,039,059 (issued to Bran). According to Bran's patent, a cleaning apparatus vibrates cleaning solution, supplied onto the semiconductor substrate, using a megasonic energy to thereby clean the semiconductor substrate. The cleaning apparatus includes an elongate quartz probe for applying the megasonic energy to the cleaning solution. In addition, U.S. Patent Laid-Open Publication No. 2001-32657 discloses a megasonic treatment apparatus having a megasonic transducer for applying mechanical vibrations to cleaning solution or etching solution supplied onto a semiconductor substrate.

FIG. 1 shows a semiconductor substrate cleaning apparatus having a quartz probe. Referring to FIG. 1, a semiconductor substrate W is loaded on a chuck 110 having the shape of a disc. The chuck 110 is rotated by a motor 120. The chuck 110 includes an annular ring 112 for supporting the semiconductor substrate W, a hub 114 disposed atop a rotating shaft 122, and a plurality of spokes 116 connecting the hub 114 to the annular ring 112.

A first nozzle 130 is provided above the semiconductor substrate W loaded on the chuck 110 in order to supply cleaning solution onto an upper surface of the semiconductor substrate W. A second nozzle 132 passes through one side of the bowl 140 so as to supply cleaning solution to the lower surface of the semiconductor substrate W loaded on the chuck 110. A bowl 140 surrounds the chuck 110 in order to confine cleaning solution that is flung off of the semiconductor substrate W during its rotation. A discharge port 150 is connected to the bottom of the bowl 140 so as to discharge cleaning solution that has flown from the semiconductor substrate W. The rotating shaft 122 extends through the center of the bottom of the bowl 140 to transfer the driving force of the motor 120 to the chuck 110. The bowl 140 has a slot 140a extending vertically through one side thereof, and a quartz probe 160 extends into the bowl 140 through the slot 140a in order to apply ultrasonic vibrations to the cleaning solution supplied onto the upper surface of the semiconductor substrate W.

The quartz probe 160 has the form of an elongate rod and extends from a peripheral portion of the semiconductor substrate W to the center of the semiconductor substrate W. Also, the quartz probe 160 is disposed parallel to the semiconductor substrate W while being spaced from the upper surface of the semiconductor substrate W by a predetermined distance. An ultrasonic vibration section 170 for producing the ultrasonic vibrations is connected to a rear end of the quartz probe 160.

Hereinafter, the cleaning of the semiconductor substrate W using the cleaning apparatus 100 will be described.

First, the semiconductor substrate W is loaded on the chuck 110. Then, the motor 120 is operated to rotate the semiconductor substrate W. At this time, the first and second nozzles 130 and 132 supply cleaning solution onto upper and lower surfaces of the semiconductor substrate W.

The cleaning solution supplied onto the upper surface of the semiconductor substrate W flows between the quartz probe 160 and the upper surface of the semiconductor substrate W due to the rotation of the semiconductor substrate W. Then, ultrasonic vibrations are applied to the cleaning solution that has flown between the quartz probe 160 and the semiconductor substrate W. The vibrating cleaning solution removes fine particles that have attached to the upper surface of the semiconductor substrate W.

At this time, a chemical can be supplied onto the upper surface of the semiconductor substrate W so as to remove impurities or unnecessary films from the upper surface of the semiconductor substrate W. In this case, the ultrasonic vibrations can promote a chemical reaction between chemical and the unnecessary films or impurities attached to the upper surface of the semiconductor substrate W, so that the impurities or unnecessary films can be even more effectively removed from the upper surface of the semiconductor substrate W.

Cleaning solution separated from the upper surface or the lower surface of the semiconductor substrate W flows to the bottom of the bowl 140, and is discharged from the bowl 140 through the discharge port 150 connected to the bottom of the bowl 140.

However, one problem with the quartz probe 160 is that it can not be adapted for use with large semiconductor substrates because the length to which the quartz probe 160 can be fabricated is limited. In addition, the ultrasonic vibrations reduce the life span of the quartz probe 160.

Still further, minute patterns on the semiconductor substrate can be damaged by ultrasonic vibrations when the ultrasonic vibrations are directly applied to cleaning solution supplied onto the upper surface of the semiconductor substrate W. The damage to these patterns is most serious at the edge of the semiconductor substrate W closest to the ultrasonic vibration section 170. The reason for this is that the intensity of ultrasonic vibrations are strongest adjacent the ultrasonic vibration section 170 and diminishes the further one goes from the vibration section 170 along the quartz probe 160. If the power of the ultrasonic vibration section 170 is lowered to prevent the pattern at the edge of the semiconductor substrate W from being damaged, impurities are not sufficiently removed from the center of the semiconductor substrate W.

In addition, ultrasonic vibrations applied to cleaning solution on the upper surface of the semiconductor substrate W is abnormally amplified due to the reflection of waves from the upper surface of the semiconductor substrate W. The amplified ultrasonic vibrations are particularly likely to damage minute patterns formed on the upper surface of the semiconductor substrate W.

### SUMMARY OF THE INVENTION

An object of the present invention is to solve the above-described problems of the prior art. Therefore, one object of the present invention is to provide an apparatus for cleaning a semiconductor substrate, which can uniformly apply vibrations to cleaning solution on the semiconductor substrate regardless of the size of the semiconductor substrate. Another object of the present invention is to provide an apparatus for cleaning a semiconductor substrate, which is not likely to damage even minute patterns on the semiconductor substrate.

To achieve these objects, the present invention provides an apparatus for cleaning a semiconductor substrate having a vertically oriented probe. In the apparatus, a rotary chuck supports the semiconductor substrate. A cleaning solution supply section supplies a cleaning solution onto a surface of the semiconductor substrate supported by the chuck. The probe can be positioned in contact with the cleaning solution supplied onto the upper surface of the substrate. A vibration section is connected to the probe so as to vibrate the probe. In addition, the probe is supported so as to be movable horizontally over the surface of the substrate and has a sectional area that gradually increases in a direction towards the chuck, i.e., towards the semiconductor substrate.

A heat-transfer member is connected to an upper portion of the probe and is made of a material having a thermal conductivity that is greater than the thermal conductivity of the probe. Also, the heat transfer member may have a coolant supply passage therein through which fluid may be circulated to regulate the temperature of the probe in contact with the cleaning solution on the upper surface of the substrate. The vibration section is connected to the probe via the heat-transfer member.

According to another aspect of the present invention, the vibration section comprises a piezoelectric transducer that converts electrical energy into ultrasonic physical vibrational energy. The heat-transfer member is acoustically connected to the piezoelectric transducer. A housing receives the piezoelectric transducer and the heat-transfer member. The probe is acoustically coupled to a lower surface of the heat-transfer member through the housing. A horizontal arm is connected to the housing and extends horizontally therefrom. A driving section swings the horizontal arm about a vertical axis.

In addition, the lower surface of the probe that makes contact with cleaning solution supplied may have a texture formed by surface features. These surface features comprise protrusions and/or grooves at the lower surface of the probe.

According to the present invention, vibrations are uniformly applied to the cleaning solution on the upper surface of the semiconductor substrate due to the rotation of the chuck and the horizontal movement of the probe. In addition, the vibrations are widely distributed to the cleaning solution because the sectional area of the lower surface of the probe is relatively large. In addition, the surface features at the lower surface of the probe that contacts the cleaning solution disperse the vibrational wavefronts reflected from the surface of the semiconductor substrate, thereby preventing the vibrations applied to the cleaning solution from being excessively amplified. Thus, even minute patterns formed on the upper surface of the semiconductor substrate can be prevented from being damaged by the vibrations.

### BRIEF DESCRIPTION OF THE DRAWINGS

The above and other objects, features and advantages of the present invention will become more apparent from the following detailed description of the preferred embodiments thereof made with reference to the attached drawings, in which:

FIG. 1 is a schematic view of a conventional apparatus for cleaning a semiconductor substrate;

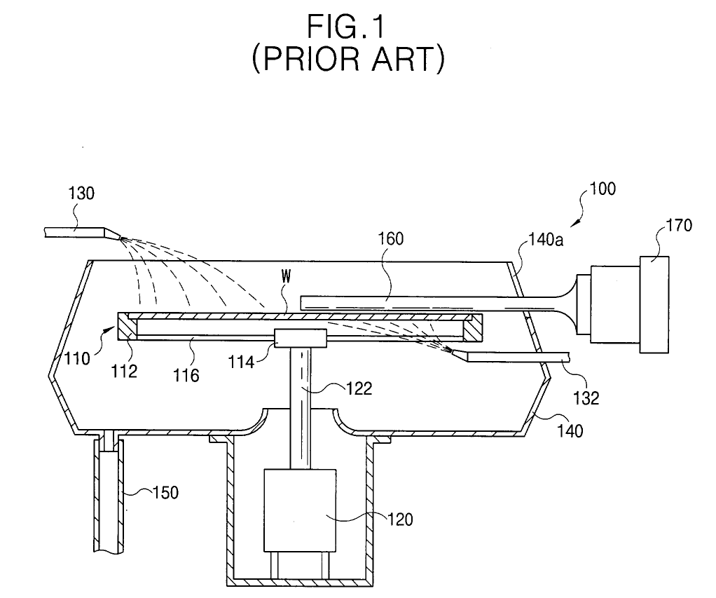

FIG. 2 is a schematic view of a first embodiment of an apparatus for cleaning a semiconductor substrate according to the present invention;

FIG. 3 is a sectional view of a probe and an ultrasonic vibration section of the cleaning apparatus shown in FIG. 2;

FIG. 4 is a plan view of the probe showing its movement during operation;

FIG. 5 is a side view of the probe and ultrasonic vibration section of the cleaning apparatus;

FIG. 6A is a view of the bottom surface of the probe of the cleaning apparatus according to the present invention;

FIGS. 6B and 6C are views of the bottom surfaces of other forms, respectively, of the probe according to the present invention;

FIG. 7 is a schematic view of a second embodiment of an apparatus for cleaning a semiconductor substrate according to the present invention;

FIG. 8 is a sectional view of a probe and an ultrasonic vibration section of the apparatus for cleaning a semiconductor substrate shown in FIG. 7;

FIG. 9 is a plan view of the probe of the second embodiment of the cleaning apparatus according to the present invention, showing the movement of the probe during operation;

FIG. 10 is a side view of the probe and ultrasonic vibration section of the second embodiment of the cleaning apparatus shown in FIG. 7; and

FIG. 11 is a view of the bottom surface of a probe of the second embodiment of the cleaning apparatus shown in FIG. 7.

### DETAILED DESCRIPTION OF THE PREFERRED EMBODIMENTS

Hereinafter, preferred embodiments of the present invention will be described in detail with reference to accompanying drawings.

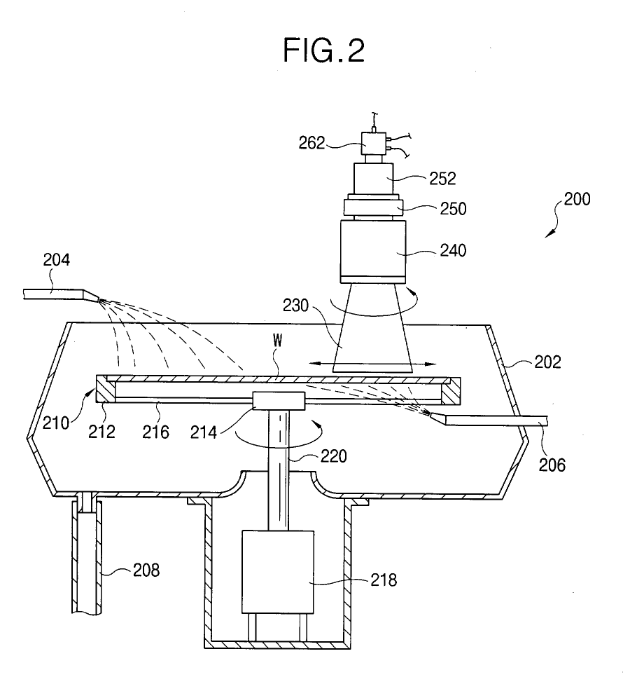

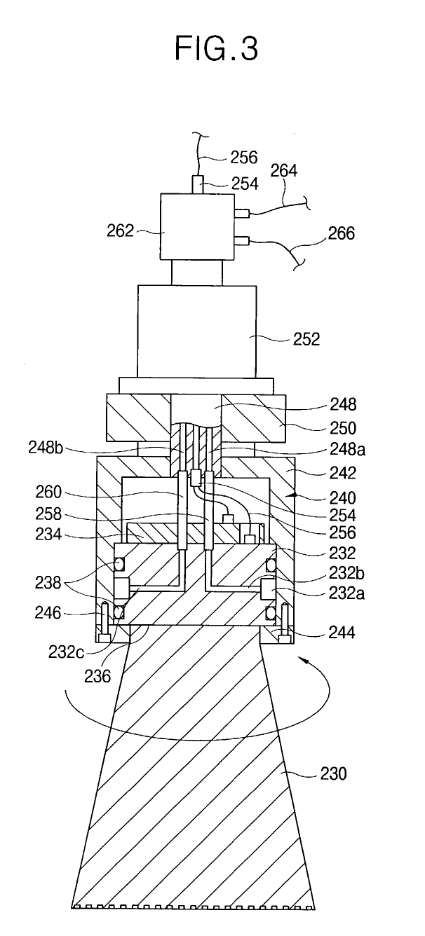

Referring to FIGS. 2 and 3, a semiconductor substrate cleaning apparatus 200 includes a chuck 210 for rotatably supporting a semiconductor substrate W. The chuck 210 includes a hub 214 connected to a first rotating shaft 220, an annular ring 112 for supporting the semiconductor substrate W, and a plurality of spokes 216 connecting the hub 214 to the annular ring 212.

A bowl 202 extends around the chuck 210 to block cleaning solution dispersed from the semiconductor substrate W due to the rotation of the semiconductor substrate W. Cleaning solution collected in the bowl 202 is discharged out of the bowl 202 through a discharge port 208 connected to the bottom of the bowl 202. A first rotating shaft 220 extends from a motor 218 through the center of the bottom of the bowl 202 and to the hub 214 of the chuck 210. The shaft 220 transfers a driving force from the motor 218 to the chuck 210 to rotate the semiconductor substrate W loaded on the chuck 210. The bowl 202 can be moved up and down to facilitate the loading and unloading of the semiconductor substrate W.

A cleaning solution supplying section for supplying a cleaning solution onto a surface of the semiconductor substrate W loaded on the chuck 210 includes a first nozzle 204 for supplying cleaning solution onto an upper surface of the semiconductor substrate W and a second nozzle 206 for supplying cleaning solution onto a lower surface of the semiconductor substrate W. The first nozzle 204 is disposed above the chuck 210. The second nozzle extends through a sidewall of the bowl 202 below the chuck 210. The cleaning solution may include deionized water, a mixture of HF and deionized water, a mixture of NH₄OH, H₂O₂ and deionized water, a mixture of NH₄F, HF and deionized water, or a mixture of H₃PO₄ and deionized water, for example.

Generally, deionized water is used for removing impurities attached to the semiconductor substrate W and for rinsing the semiconductor substrate W.

A mixture (DHF) of HF and deionized water is used for removing SiO₂ and metal ions from the semiconductor substrate W. To this end, the ratio of HF to deionized water in the mixture is usually 1:100 to 1:500. However, the ratio that is used depends on the conditions of the cleaning process.

A mixture of NH₄OH, H₂O₂ and deionized water, generally referred to as SC1 (standard clean 1) solution, is used for removing oxide layers formed on the semiconductor substrate W, or organic material attached to the semiconductor substrate W. The NH₄OH, H₂O₂ and deionized water are typically mixed in a ratio of 1:4:20 to 1:4:100. However, the mixing ratio is, again, selected based on the conditions of the particular cleaning process.

In addition, a mixture of NH₄F, HF and deionized water, referred to as Lal solution, is used for removing oxide layers from the semiconductor substrate W. A mixture of H₃PO₄ and deionized water is used for removing nitride-based impurities that cannot be removed by the Lal solution.

Also, note, the efficiency of the cleaning solution improves as the temperature of the cleaning solution is made higher. Thus, the cleaning apparatus 200 has means to adjust the temperature of the cleaning solution. In addition, the cleaning apparatus 200 may be designed to selectively employ any of the above-described cleaning solutions depending on the kind of impurities to be removed.

A probe 230 disposed above the chuck 210 makes contact with the cleaning solution that has been supplied onto the upper surface of the semiconductor substrate W through the first nozzle 204. The sectional area of the probe 230 is circular and gradually increases in a direction towards the semiconductor substrate W. Accordingly, the diameter of the lower surface of the probe 230 that contacts the cleaning solution supplied onto the upper surface of the semiconductor substrate W is larger than that of the upper surface of the probe 230. The probe 230, however, can have other cross-sectional shapes besides circular.

A heat-transferring member 232 is acoustically coupled to the upper surface of the probe 230. In addition, an ultrasonic vibration section 230 for converting electrical ultrasonic energy to physical ultrasonic vibrational energy is acoustically coupled to an upper surface of the heat-transferring member 232. Preferably, the probe 230 is bonded to the heat-transferring member 232 by means of an adhesive layer 236. In addition, a thin metal screen having a plurality of holes therein can be interposed between the probe 230 and the heat-transferring member 232.

The ultrasonic vibration section 234 includes a piezoelectric transducer, which converts electric energy to physical vibrational energy. In addition, the probe 230 is preferably fabricated of quartz, which effectively transfers the ultrasonic energy. The quartz probe 230 can be adapted for use with most of the cleaning solutions, except for HF cleaning solution, because HF is capable of etching quartz. In that case, sapphire, silicon carbide or boron nitride can be used instead of quartz. Alternatively, the quartz probe 230 can be coated with silicon carbide or vitreous carbon, which are resistant to the corrosive effect of HF.

The heat-transferring member 232 is cylindrical and comprises a material having a thermal conductivity that is greater than the thermal conductivity of the probe 230. For example, the heat-transferring member 232 comprises copper or aluminum having a high degree of thermal conductivity. A first annular groove 232a is formed at a side of the heat-transferring member 232. A coolant for adjusting the temperature of the heat-transferring member 232 is supplied into the first annular groove 232a. Second and third annular grooves are formed at the side of the heat-transferring member above and below the first annular groove 232a, respectively. A respective sealing member, such as an O-ring 238, is inserted into each of the second and third annular grooves in order to prevent the coolant from leaking.

The heat-transferring member 232 and the ultrasonic vibration section 234 are accommodated in a housing 240. The housing 240 includes a cylindrical cup 242 and a cover 244. An annular recess is formed at an inner wall of the cup 242 so as to receive the heat-transferring member 232, and an opening for receiving the probe 230 is formed at the center of the cover 244. The cup 242 is coupled to the cover 244 by means of a plurality of bolts 246.

A second rotating shaft 248 is connected to an upper portion of the housing 240. The rotating shaft 248 is connected to a second motor 252 for rotating the probe 230. The second motor 252 is installed on an upper surface of a horizontal arm 250 and the housing 240 is connected to the rotating shaft 248, which extends from the motor 252 through the horizontal arm 250.

An ultrasonic energy source (not shown) and the ultrasonic vibration section 234 are connected to each other through a plurality of electric connectors 254 and wires 256. The wires 256 are passed through the second rotating shaft 248 so as to be connected to the ultrasonic vibration section 234.

The heat-transferring member 232 has a first coolant supplying path 232b and a first coolant discharging path 232c at an inner portion thereof. The first coolant supplying path 232b and the first coolant discharging path 232c are connected to the first annular groove 232a. The rotating shaft 248 has a second coolant supplying path 248a and a second coolant discharging path 248b at an inner portion thereof. A first connection pipe 258 connects the first coolant supplying path 232b to the second coolant supplying path 248a and a second connection pipe 260 connects the first coolant discharging path 232c to the second coolant discharging path 248b, within the housing 240. A rotary valve 262 is connected to an upper portion of the rotating shaft 248, and a coolant supplying line 264 and a coolant discharging line 266 are respectively connected to the second coolant supplying path 248a and the second coolant discharging path 248b via the rotary valve 262.

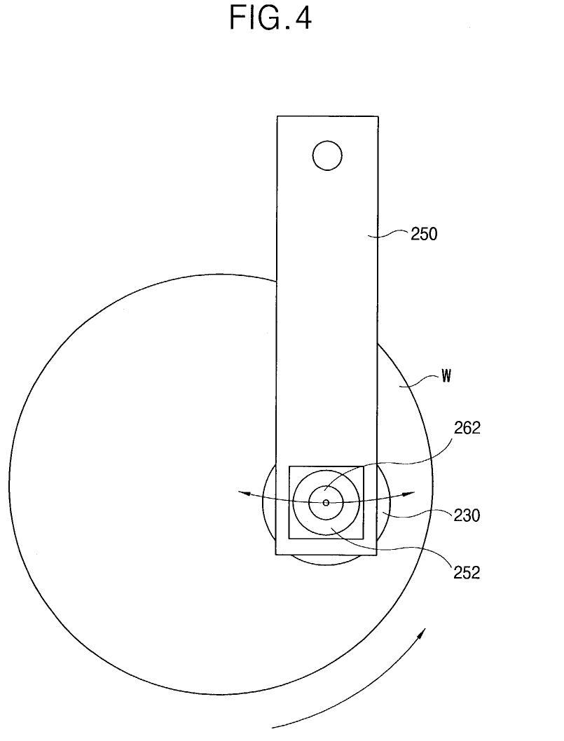

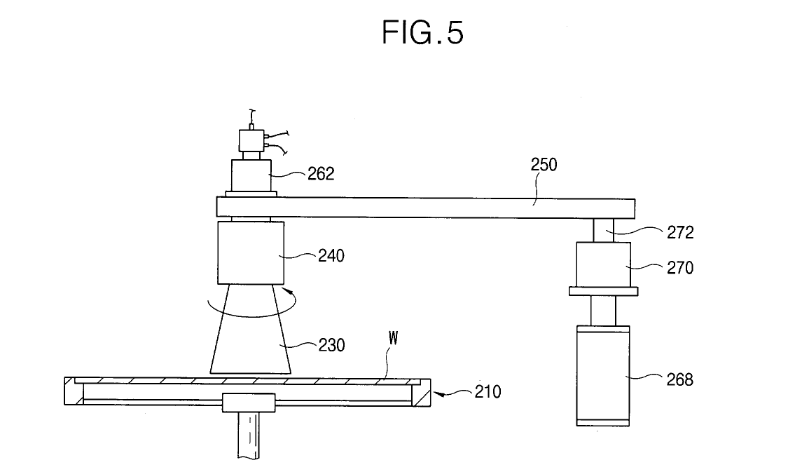

Referring now to FIGS. 4 and 5, a pneumatic cylinder 268 is disposed at one side of the bowl 202 (refer to FIG. 2) in order to adjust the relative height of the probe 230. The pneumatic cylinder 268 is connected to a third motor 270 for swinging the probe 230 horizontally about the longitudinal axis of a third rotating shaft 272 connected to the horizontal arm 250. Alternatively, the vertical movement of the probe 230 can be carried out by means of a ball screw type of driving device.

The ultrasonic vibrations produced by the probe 230 can be uniformly applied to cleaning solution on the upper surface of the semiconductor substrate W, due to the rotation of the semiconductor substrate W and the horizontal movement of the probe 230. The ultrasonic vibrational energy is widely distributed to the cleaning solution owing to the design of the probe 230, i.e., the relatively large sectional area of the bottom surface of the probe 230. Accordingly, minute patterns formed on the semiconductor substrate W will not be damaged.

The ratio of the diameter of the lower surface of the probe 230 to the radius of the semiconductor substrate W is preferably about 0.2-1:1. More preferably, the diameter of the lower surface of the probe 230 is a half the radius of the semiconductor substrate W. If the ratio of the diameter of the lower surface of the probe 230 to the radius of the semiconductor substrate W is less than 0.2:1, a long time is required for performing the cleaning process. If the diameter of the lower surface of the probe 230 is greater than the radius of the semiconductor substrate W, it is difficult to supply the cleaning solution between the probe 230 and the semiconductor substrate W.

As was described in connection with the related art, ultrasonic vibrations supplied onto the upper surface of the semiconductor substrate W will be reflected from the upper surface of the semiconductor substrate W, thereby amplifying the ultrasonic vibrations applied to cleaning solution. These amplified vibrations are likely to damage a pattern formed on the semiconductor substrate. In addition, in the present invention, ultrasonic vibrations generated by the ultrasonic vibration section 234 are directly transferred to the upper surface of the semiconductor substrate W through the probe 230. Accordingly, the direction of propagation of the ultrasonic vibrations is identical to the direction of vibration of the cleaning solution. If unchecked, this phenomena is also very likely to damage any fine pattern on the semiconductor substrate.

As a countermeasure to these potential problems, the lower surface of the probe 230 may have surface features providing a texture to the surface. The surface features are designed to disperse the waves reflected from the surface of the semiconductor substrate W, thereby preventing the ultrasonic vibrations from being excessively amplified. In addition, the surface features create a variation in the direction of vibration of the cleaning solution along with the rotation of the probe 230.

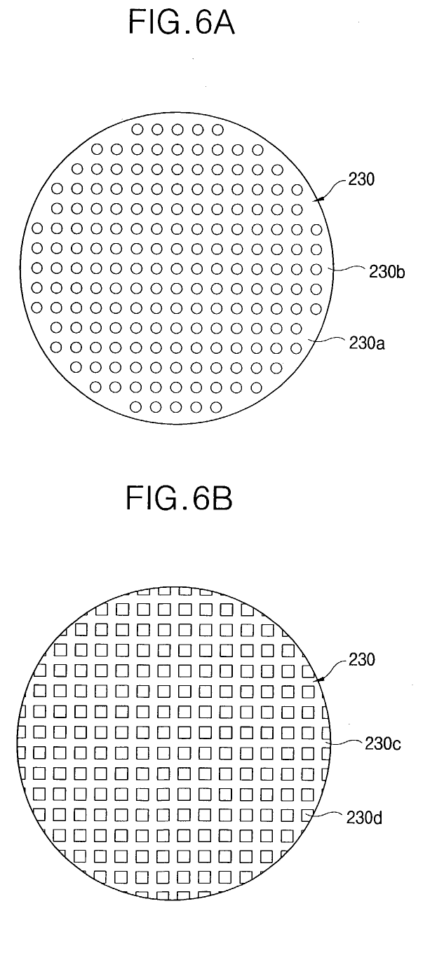

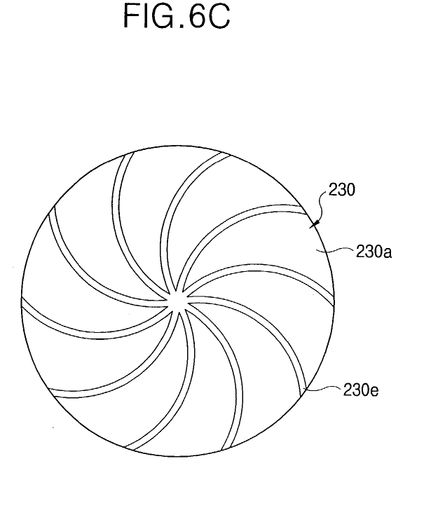

For example, referring to FIG. 6A, a plurality of protrusions 230b are formed at the lower surface 230a of the probe 230 in order to prevent the ultrasonic vibrations from being excessively amplified. That is, the vibrational wavefront reflected from the surface of the semiconductor substrate W is dispersed by the protrusions, thereby preventing the ultrasonic vibrations from being excessively amplified. As shown in the figure, the protrusions at the lower surface 230a of the probe 230 may have the form of dimples.

Referring to FIG. 6B, a plurality of grooves 230c are formed at the lower surface 230a of the probe 230 orthogonally to each other. The grooves 230 form a plurality of protrusions 230d at the lower surface 230a of the probe 230. The plurality of grooves 230c and protrusions 230d prevent the ultrasonic vibrations from being excessively amplified. In addition, the grooves 230c allow the cleaning solution to flow easily between the probe 230 and the semiconductor substrate W.

Referring to FIG. 6C, a plurality of spiral grooves 230e in a form of a pinwheel are formed at the lower surface 230a of the probe 230. The spiral grooves 230e also prevent the ultrasonic vibrations from being excessively amplified and allow the cleaning solution to readily flow between the probe 230 and the semiconductor substrate W.

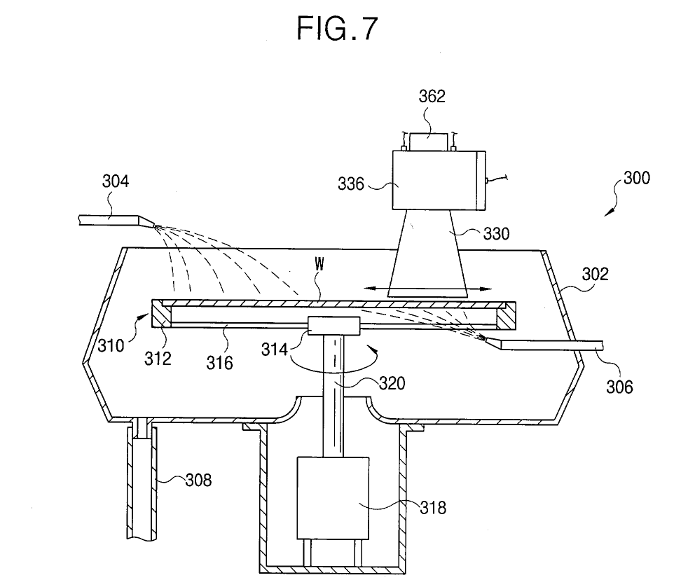

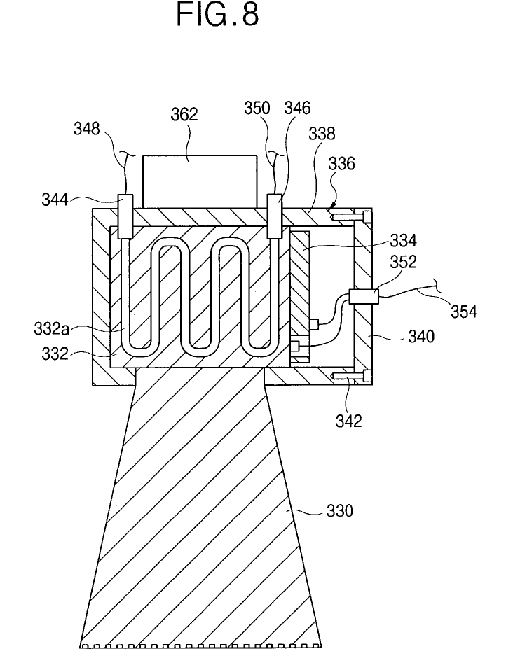

FIGS. 7 and 8 show a second embodiment of an apparatus for cleaning a semiconductor substrate according to the present invention.

The semiconductor second embodiment of the substrate cleaning apparatus 300 according to the present invention includes a chuck 310 rotatably supporting the semiconductor substrate W, a cleaning solution supplying section for supplying cleaning solution onto the upper and lower surfaces of the semiconductor substrate W loaded on the chuck 310, a bowl 302 for collecting cleaning solution dispersed from the rotating semiconductor substrate W, a probe 330 that is-disposed above the chuck 310 so as to overlie the upper surface of the semiconductor substrate W supported by the chuck 310, a heat-transferring member 332 coupled to the upper surface of the probe 330, and an ultrasonic vibration section 334 that generates ultrasonic vibrations.

The chuck 310 includes a hub 314, an annular ring 312 for supporting outer peripheral portion of the semiconductor substrate W, and a plurality of spokes 316 connecting the hub 314 to the annular ring 312. The bowl 302 is positioned around the chuck 310 and a discharging port 308 is connected to a lower portion of the bowl 302 in order to discharge cleaning solution out of the bowl 302. A first motor 318 is connected to the hub 314 by a first rotating shaft 320 for driving the chuck 310.

The cleaning solution supplying section includes a first nozzle 304 for supplying cleaning solution onto the upper surface of the semiconductor substrate W, and a second nozzle 306 for supplying cleaning solution onto the lower surface of the semiconductor substrate W.

The probe 330 contacts the cleaning solution supplied on the upper surface of the semiconductor substrate W and applies ultrasonic vibrations to the cleaning solution. As with the first embodiment, the probe 330 is basically oriented vertically with respect to the semiconductor substrate W. Also, the cross-sectional area of the probe 330 gradually increases towards the semiconductor substrate W. The probe 330 shown in FIGS. 7 and 8 has a circular cross section. Thus, the lower surface of the probe 330 making contact with cleaning solution has a diameter greater than the diameter of the upper surface of the probe 330.

The heat-transferring member 332 is coupled to the upper surface of the probe 330. The heat-transferring member 332 has a hexahedral shape. A fluid passage 332a for supplying coolant is formed in the heat-transferring member 332. The ultrasonic vibration section 334 for converting electrical ultrasonic energy into physical vibrational energy is coupled to one side of the heat-transferring member 332. The probe 330 is acoustically coupled to the heat-transferring member 332 by an adhesive. A porous metal screen can be interposed between the probe 330 and the heat-transferring member 332. The ultrasonic vibration section 334 is acoustically coupled to the heat-transferring member 332 by an adhesive. Physical ultrasonic vibrations generated by the ultrasonic vibration section 334 are transferred to the probe 330 through the heat-transferring member 332.

The heat-transferring member 332 and the ultrasonic vibration section 334 are accommodated in a rectangular housing 336. The housing 336 includes a cup 338 whose body has a rectangular cross section, and a cover 340. The cup 338 is coupled to the cover 340 by a plurality of bolts 342. The cup 338 is oriented horizontally. The probe 330 is received in an opening at a lower portion of the cup 338. The probe 330 is coupled to the heat-transferring member 332 accommodated in the cup 338 through the opening. The fluid passage 332a of the heat-transferring member 332 is connected to first and second connectors 344 and 346, which extend through an upper portion of the cup 338. The first and second connectors 344 and 346 are connected to a coolant supplying line-348 and a coolant discharging line 350, respectively. An ultrasonic energy source (not shown) and the ultrasonic vibration section 334 are connected by a wire 354 via an electrical connector 352 that extends through the cover 340.

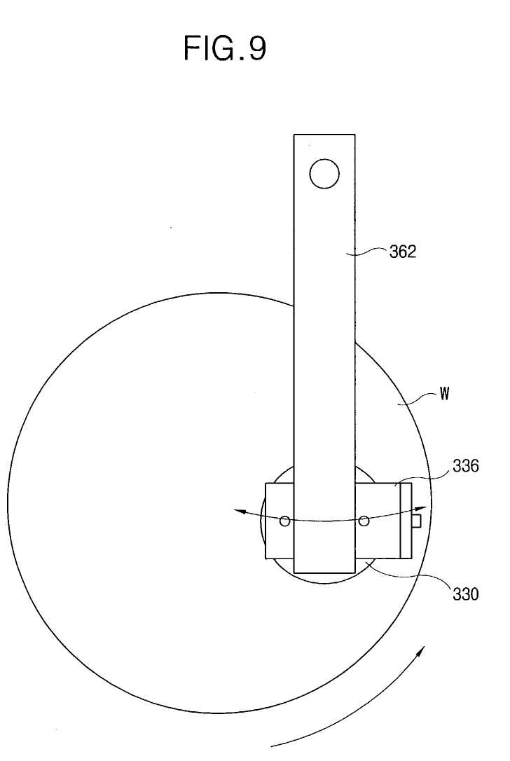

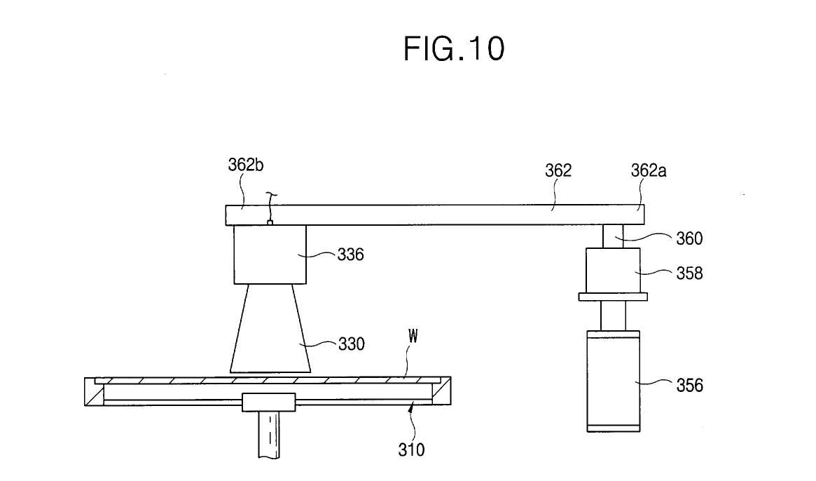

Referring to FIGS. 9 and 10, a pneumatic cylinder 356 is disposed at one side of the bowl 302 (refer to FIG. 7) in order to adjust the relative height of the probe 330. The pneumatic cylinder 356 is connected to a second motor 358 for swinging the probe 330 horizontally about the longitudinal axis of a second rotating shaft 360 connected to a horizontal arm 362. The ultrasonic vibrations produced by the probe 330 can be uniformly applied to cleaning solution on the upper surface of the semiconductor substrate W, due to the rotation of the semiconductor substrate W and the horizontal movement of the probe 330. The ultrasonic vibrational energy is widely distributed to the cleaning solution owing to the design of the probe 330, i.e., the relatively large sectional area of the bottom surface of the probe 330. Accordingly, minute patterns formed on the semiconductor substrate W will not be damaged.

In addition, the direction in which the ultrasonic vibrational energy is transferred to the probe 230 is one that is parallel to the semiconductor substrate W. The ultrasonic vibrational energy is indirectly applied to cleaning solution on the upper surface of the semiconductor substrate W through the probe 330 that is oriented vertically relative to the semiconductor substrate 330. Accordingly, minute patterns on the semiconductor substrate W will not be damaged.

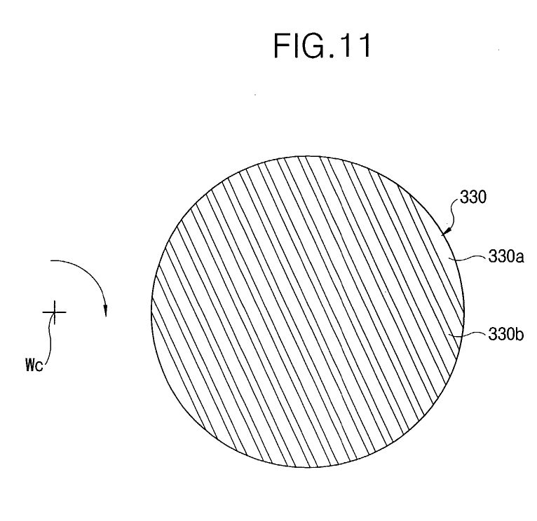

In addition, the lower surface of the probe 330 has surface features designed to prevent the ultrasonic vibrations from being excessively amplified. More specifically, the lower surface of the probe 330 can have the surface features shown in FIGS. 6A and 6B, or can those shown in FIG. 11. Referring to FIG. 11, grooves 330b are formed at the lower surface 330a of the probe in a direction identical to the direction of flow of the cleaning solution caused by the rotation of the semiconductor substrate W. The cross-shaped mark Wc shown in FIG. 11 indicates the center of the semiconductor substrate W. In addition, the arrow in FIG. 11 shows the rotational direction of the semiconductor substrate W.

As described above, according to the present invention, the probe is oriented vertically so as to make contact with cleaning solution on the upper surface of the semiconductor substrate. The probe has a cross-sectional area that gradually increases towards the semiconductor substrate, and an ultrasonic vibration section is connected to the upper surface of the probe. Accordingly, ultrasonic vibrations applied to cleaning solution through the probe are widely distributed. In addition, the surface features formed at the lower surface of the probe disperse the vibrational wavefront reflected from the semiconductor substrate, thereby preventing the ultrasonic vibrations from being excessively amplified. Thus, any minute patterns formed on the semiconductor substrate can be prevented from being damaged.

In addition, the ultrasonic vibrations are applied uniformly to the cleaning solution, due to the rotation of the semiconductor substrate and the horizontal movement of the probe. Hence, the cleaning efficiency is enhanced.

Finally, although the present invention has been described in detail with reference to the preferred embodiments thereof, it should be understood to those skilled in the art that various changes, substitutions and alterations can be made thereto without departing from the true spirit and scope of the invention as defined by the appended claims.

What is claimed is:

1. An apparatus for cleaning a semiconductor substrate, the apparatus comprising:
a chuck configured to support a semiconductor substrate;
a cleaning solution supplying section that supplies a cleaning solution onto a surface of a semiconductor substrate supported by said chuck;
a probe extending longitudinally vertically above said chuck so as to be movable horizontally, and having a cross-sectional area that increases in a direction towards said chuck; and
a vibration section connected to said probe, and operative to produce vibrations that are transferred to said probe.

2. The apparatus as claimed in claim 1, wherein the probe has a circular cross section.

3. The apparatus as claimed in claim 1, and further comprising a heat-transfer member connected to an upper portion of said probe and comprising a material having a thermal conductivity that is greater than the thermal conductivity of said probe.

4. The apparatus as claimed in claim 3, wherein the heat-transfer member is acoustically coupled to the upper surface of the probe, and the vibration section is acoustically coupled to an upper surface of the heat-transfer member.

5. The apparatus as claimed in claim 4, wherein the heat-transfer member is cylindrical.

6. The apparatus as claimed in claim 3, wherein the heat-transfer member is acoustically coupled to an upper surface of the probe, and the vibration section is acoustically coupled to a lateral side surface of the heat-transfer member and is oriented to produce horizontally propagating vibrations that are transferred to said probe via said heat transfer member.

7. The apparatus as claimed in claim 6, wherein said heat-transfer member has a hexahedral shape.

8. The apparatus as claimed in claim 3, wherein said heat-transfer member has a coolant supplying passage extending through an inner portion thereof.

9. The apparatus as claimed in claim 1, and further comprising a housing in which the vibration section is received.

10. The apparatus as claimed in claim 9, and further comprising a driving section connected to said housing and operative to swing said probe in a horizontal plane about a vertical axis.

11. The apparatus as claimed in claim 9, and further comprising a horizontal arm connected to said housing and extending horizontally therefrom, and a driving section connected to said horizontal arm and operative to swing the horizontal arm in a horizontal plane about a vertical axis.

12. The apparatus as claimed in claim 11, and further comprising a second driving section, connected to the horizontal arm, and operative to move said probe vertically.

13. The apparatus as claimed in claim 1, wherein said probe has a textured lower surface defined by a plurality of surface features.

14. The apparatus as claimed in claim 13, wherein said surface features are a plurality of dimples.

15. The apparatus as claimed in claim 13, wherein said surface features are a plurality of grooves that extend perpendicular to each other.

16. The apparatus as claimed in claim 13, wherein said surface features are a plurality of spiral grooves that collectively have the shape of a pinwheel.

17. An apparatus for cleaning a semiconductor substrate, the apparatus comprising:
a chuck configured to support a semiconductor substrate;
a cleaning solution supplying section that supplies a cleaning solution onto a surface of a semiconductor substrate supported by said chuck;
a piezoelectric transducer operable to convert electrical energy into ultrasonic physical vibrational energy;
a heat-transfer member acoustically coupled to said piezoelectric transducer and having a coolant supply passage therein;
a housing in which said piezoelectric transducer and said heat-transfer member are received; and
a probe acoustically coupled to a lower surface of said heat-transfer member through the housing and vertically extending therefrom, whereby the probe may contact cleaning solution on an upper surface of a semiconductor substrate supported by said chuck in order to apply ultrasonic vibrational energy to the cleaning solution, and said probe having a cross-sectional area that increases towards said chuck;
a horizontal arm connected to said housing so as to extend horizontally therefrom; and
a driving section connected to said arm and operative to swing the arm in a horizontal plane about a vertical axis.

18. The apparatus as claimed in claim 17, wherein said probe has a circular cross section.

19. The apparatus as claimed in claim 17, wherein said probe has a textured lower surface defined by a plurality of surface features.

20. The apparatus as claimed in claim 17, wherein said piezoelectric transducer is coupled to an upper surface of the heat-transfer member by adhesive.

21. The apparatus as claimed in claim 17, wherein said piezoelectric transducer is coupled to a lateral side surface of said heat-transfer member by adhesive and said piezo-electric transducer is oriented to produce horizontally propagating vibrations that are transferred to said probe via said heat transfer member.
